(19) United States
(12) Patent Application Publication
(10) Pub. No.: US 2002/0184044 A1
(43) Pub. Date: Dec. 5, 2002

(54) Method and apparatus for valuing patent assets

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 09/874,870

(22) Filed: Jun. 5, 2001

(51) Int. Cl. G06F 17/60

(52) U.S. Cl. 705/1

(57) ABSTRACT

A method for valuing patent assets in function of a “cash out” profits stream. The method hypothesizes a patent holder that grants fee-based licenses under its patent assets to all interested third parties, thereby retaining no exclusionary rights from which to reap excess profits for its own sale of patented articles. Applying this “cash out” hypothesis, the value of the patent assets is determined in function of the sum of the projected licensing fees from such fee-based licenses, i.e. the projected “cash out” licensing profits stream. Through invocation of the “cash out” hypothesis, which removes excess profits determinations from patent asset valuation, the method: (i) simplifies and reduces information barriers to patent asset valuation; and (ii) yields owner-independent patent asset valuations more useful in comparative patent portfolio analysis. The present invention further provides a system in which a patent asset valuation method may be applied in a networked computing environment to improve automation.

### BACKGROUND OF THE INVENTION

Many entities may wish to know the value of patent assets. A venture capitalist may wish to know what patent assets are worth in order to make an informed investment decision. A financial analyst may wish to know what patent assets are worth in order to make an informed client recommendation. A potential acquiring company may wish to know what an acquisition target's patent assets are worth in order to make an informed takeover offer. And, naturally, the patent holder itself may wish to know what its patent assets are worth to inform its relations with such entities and others.

There are methodological problems in valuing patent assets. These problems are both practical and theoretical. The value of patent assets is the right to exclude others from making, using or selling the patented inventions. This value can manifest itself both in “excess profits”, that is, the patent holder's profits realized from the sale of patented articles with diminished competition, and licensing profits, that is, the patent holder's profits realized from licensing the patented inventions to others. From a practical standpoint, determining excess profits is difficult for the patent holder, which has access to complete information about its business, and even more difficult for third parties, which have only limited access to information about the patent holder's business. Determining a patent holder's licensing profits is easier for the patent holder, but is still difficult for third parties due to limited information about the patent holder's business. From a theoretical standpoint, even if excess profits and licensing profits could be readily determined, simply summing the two measures of profit over the lifetime of the patent assets would not necessarily yield a “fair market value” of the patent assets. The ability to reap excess profits from patent assets depends on factors unique to the patent holder's business, such as whether the patent assets are central or merely collateral to the business and whether or not the patent holder has sufficient resources to fully exploit the patent assets through the sale of patented articles. Therefore, the value of patent assets depends in part on their owner.

A further difficulty in valuing patent assets arises from a lack of adequate automation in applying patent asset valuation methodologies. That is, even if one were to develop a workable valuation methodology, applying the methodology would require a considerable cost and time investment. The additional cost and time investment is particularly significant if such methodology is to be applied in a large number of instances.

### SUMMARY OF THE INVENTION

The present invention addresses the above difficulties through a method and apparatus that values patent assets in function of a projected “cash out” licensing profits stream. The method hypothesizes a patent holder who grants fee-based licenses under its patent assets to all interested third parties, thereby retaining no exclusionary rights from which to reap excess profits from its own sale of patented articles. Applying this “cash out” hypothesis, a value of the patent assets is determined in function of the projected licensing profits accruing from all such fee-based licenses, i.e. a projected “cash out” licensing profits stream. Through invocation of the “cash out” hypothesis, which removes excess profits determinations from patent asset valuation, the method: (i) simplifies and reduces information barriers to patent asset valuation; and (ii) yields “owner independent” patent asset valuations that are useful in comparative patent portfolio analysis. The present invention further provides a patent asset valuation methodology that may be readily applied in a networked computing environment to improve automation.

In one aspect, a method for valuing patent assets comprises: identifying patent assets; identifying a plurality of licensing targets for the patent assets; determining a plurality of license fee data for the plurality of licensing targets, respectively; and determining a value of the patent assets in function of the plurality of license fee data.

In another aspect, a method for valuing patent assets comprises: identifying a patent holder; identifying patent assets of the patent holder; identifying a plurality of licensing targets for the patent assets; determining a plurality of license fee data for the plurality of licensing targets, respectively; and determining a value of the patent assets in function of the plurality of license fee data.

In yet another aspect, a networked computing system comprises an end-user station having a user interface, for interacting with a user, and a network interface, for interacting with a network, wherein the end-user station interacts with the network to determine a value of patent assets in response to identification of the patent assets in an interaction involving the user, and wherein the value of patent assets is determined in function of a plurality of projected license fee data for a respective plurality of projected licensing targets.

In yet another aspect, a software program has instructions for interacting with an end-user station, a user and a network to determine a value of patent assets in function of a plurality of projected license fee data for a respective plurality of projected licensing targets.

In yet another aspect, a method for valuing patent assets comprises: identifying a plurality of licensing targets in function of a projected interest in licensing the patent assets; determining a plurality of projected license fee data for the plurality of licensing targets, respectively; and determining a value of the patent assets in function of the plurality of projected license fee data.

These and other objects of the present invention may be better understood by reference to the following detailed description, taken in conjunction with the accompanying drawings briefly described below. Of course, the actual scope of the invention is defined by the appended claims.

### BRIEF DESCRIPTION OF THE DRAWINGS

FIG. 1 illustrates a networked computing environment for use in valuing patent assets;

FIGS. 2 through 5 are flow diagrams illustrating a method for determining a value for the patent assets applicable to the networked computing environment of FIG. 1.

### DETAILED DESCRIPTION OF THE PREFERRED EMBODIMENT

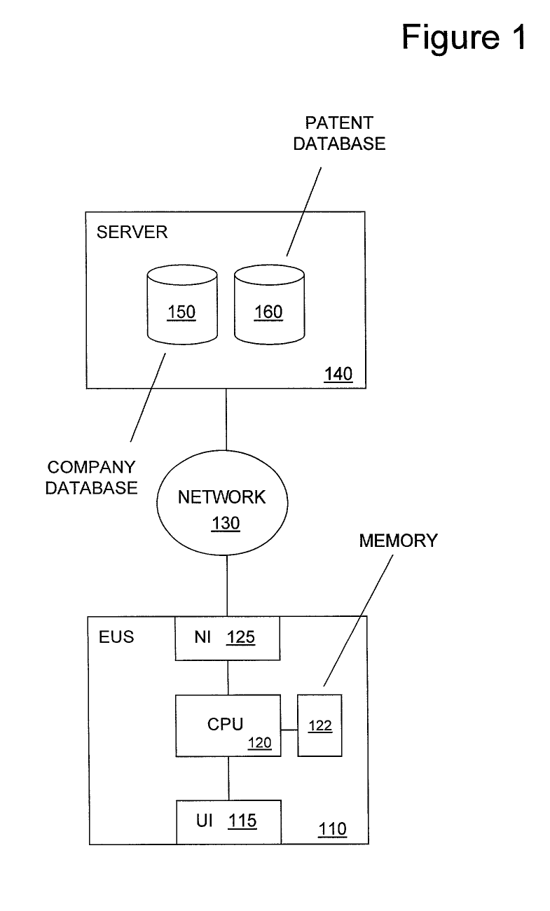

In FIG. 1, a networked computing environment for valuing patent assets in accordance with the invention is shown. The environment includes end-user station (EUS) 110, such as a personal computer or workstation, having user interface 115, processor (CPU) 120, memory 122 and network interface (NI) 125. End-user station 110 receives and transmits data on user interface 115, processes data, in conjunction with memory 122, using processor 120 and exchanges data with server 140 over network interface 125. Network interface 125 may be a wired or wireless interface. Data exchanges are performed via network 130, such as a LAN or WAN, and involve retrieving information from company database 150 and patent database 160. Memory 122 stores data, including software program instructions and data retrieved in data exchanges. Such stored data are used by processor 120 to provide functionality described herein. Company database 150 has entries for corporate entities that include official corporate names of companies comprising the entities and total revenue data for the entities. Patent database 160 has entries for patents that include patent numbers, assignee names, filing dates, grant dates, maintenance status data and patent classification numbers. Patent classification numbers may include international classification numbers or U.S. classification numbers, or both. It will be appreciated that patent classification numbers represent technological fields of patents. The entries for patents may include full-text patents. Server 140 may, in addition to databases 150, 160, include processing elements applied, for instance, in interacting with databases 150, 160 to generate search results for search queries received from end-user station 110. Of course, databases 150, 160 may in other embodiments of the invention reside on different servers.

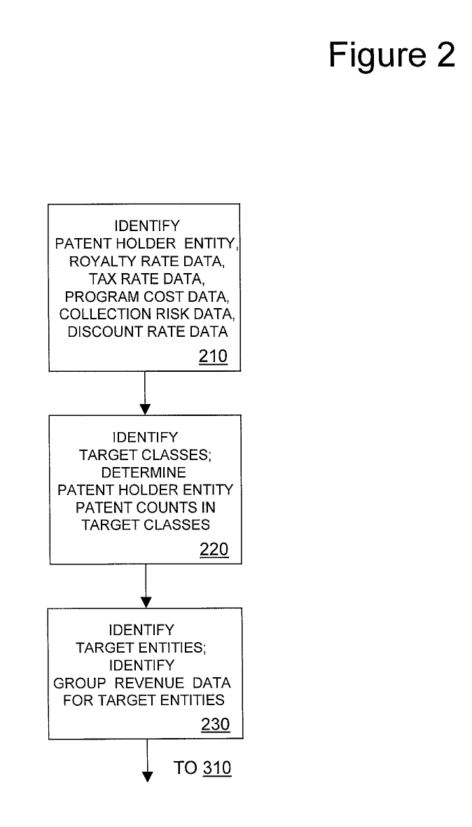

In FIGS. 2 through 5, flow diagrams illustrate a method for valuing the patent assets of a patent holder in accordance with the invention as applied within the networked computing environment of FIG. 1. Referring to Step 210, a user of end-user station 110 is prompted via user interface 115 to specify a patent holder identity, royalty rate data, tax rate data, program cost data, collection risk data and cash flow discount rate data. The user inputs the requested information on user interface 115. Processor 120 forms a patent holder entity (PHE) search query including as a search attribute the patent holder identity and the PHE search query is transmitted over network 130 from end-user station 110 to server 140 via network interface 125. At server 140, the attribute from the PHE search query is applied to company database 150 to generate a PHE search result including the official corporate names of the companies affiliated with the patent holder identity, which may include, for instance, the official corporate name of the company intended to be identified by the patent holder identity (if different) and the official corporate names of companies under affiliated therewith (if any). The group of affiliated companies is sometimes referred to herein as the “patent holder entity”. The PHE search result is transmitted from server 140 to end-user station 110 via network 130 and network interface 125 and an entry is created for the patent holder entity in memory 122 including the official corporate names of the companies within the group. Of course, identifying a patent holder entity may be accomplished without consultation of company database 150 by direct user input of the official corporate names of the companies comprising the patent holder entity.

Referring to Step 220, at end-user station 110, processor 120 forms a patent holder entity patent count and target classification (PHEPC/TC) search query including as search attributes the official corporate names of the patent holder entity. The PHEPC/TC search query is transmitted from end-user station 110 to server 140 via network 130 and interface 125. At server 140, attributes from the PHEPC/TC search query are applied to patent database 160 to generate a PHEPC/TC search result, including, for each quarter within the period of interest, patent classifications listed on patents on which one of the patent holder entity official corporate names is the listed assignee and the number of such patents active (i.e. in force) within each such classification. Such patent classifications are hereinafter sometimes referred to as “target” classifications or “target” classes. The period of interest should encompass licensing revenue opportunities for the patent assets of the patent holder to the maximum extent permitted by law. In this regard, the twenty-six year period spanning six years into the past and twenty years into the future, to correspond to the six-year statute of limitations for patent infringement and twenty-year maximum patent term, respectively, is contemplated. The PHEPC/TC search result is transmitted from server 140 to end-user station 110 via network 130 and interface 125. The patent holder entity's patent counts in the respective target classifications is added to the patent holder entity entry previously created in memory 122. The target classifications are also stored in memory 122.

It will be appreciated that, at this point in the process, identities of patent classifications in which the patent holder has owned or controlled patent assets within the period of interest, and the patent holder's patent counts in such patent classifications within the period of interest, have been learned.

Referring to Step 230, at end-user station 110, processor 120 forms a target identity (TI) search query including the target classifications as search attributes The TI search query is transmitted from end-user station 110 to server 140 via network 130 and interface 125. At server 140, attributes from the TI search query are applied to patent database 160 to generate a TI search result, including the assignees listed on patents within any of the target classifications. The TI search result is transmitted from server 140 to end-user station 110 via network 130 and interface 125. Processor 120 checks for and discards duplicate instances of assignees (e.g. assignees reported multiple times due to being listed on two or more patents within the target classifications). Processor 120 forms a target entity and target entity revenue (TE/TER) search query including as a search attribute the retained assignees from the TI search result and the TE/TER search query is transmitted over network 130 from end-user station 110 to server 140 via interface 125. At server 140, the attribute from the TE/TER search query is applied to company database 150 to generate a TE/TER search result, including for each retained assignee the official corporate names of the companies affiliated with the assignee (if any) and group revenue data for the affiliated companies for each quarter within the period of interest. Of course, the future revenues are estimates. Each group of affiliated companies is sometimes referred to herein as a “target entity”. The TE/TER search result is transmitted from server 140 to end-user station 110 via network 130 and interface 125. At end-user station 110, processor 120 checks for and discards duplicate instances of target entities (e.g. target entities reported multiple times due to two or more different assignees that are part of the same group of companies having been applied in the target data search query) and creates entries in memory 122 for each target entity including the official corporate names of the companies within the group and group revenue data.

It will be appreciated that, at this point in the process, identities of licensing targets and their total revenues during the period of interest have been learned, wherein each licensing target is a single unaffiliated company or a group of affiliated companies owning or controlling patent assets in at least one patent classification in which the patent holder also owns patent assets. The licensing targets are therefore companies or groups of affiliated companies whose patent assets exhibit at least some technological overlap with the patent assets of the patent holder, and can therefore be expected to have an interest in licensing the patent holder's patent assets.

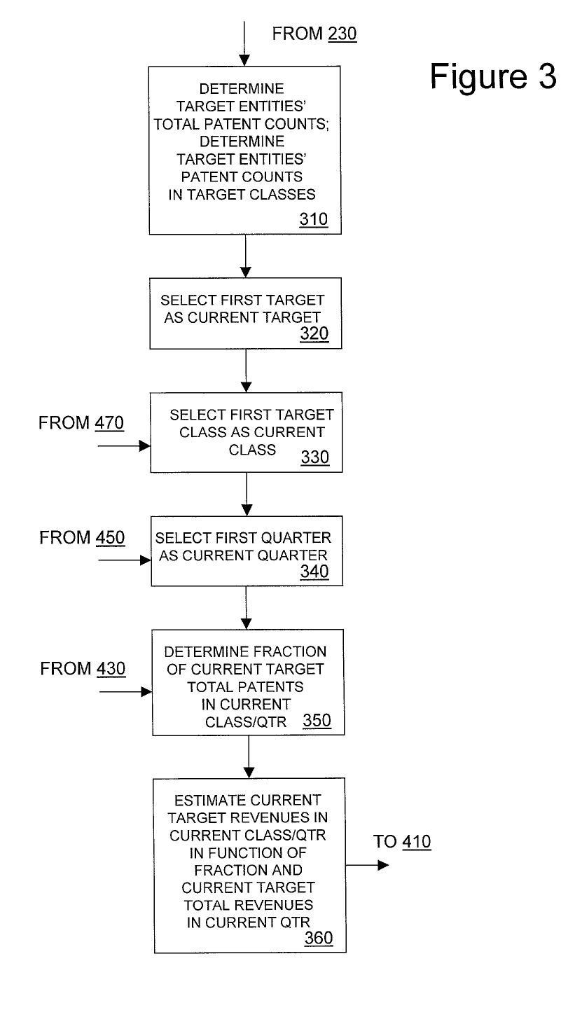

Turning now to FIG. 3, and first to Step 310, processor 120 retrieves the previously stored target entities and target classifications from memory 122 and forms a target entity patent count (TEPC) search query including as search attributes the target entities and target classifications. The TEPC search query is transmitted from end-user station 110 to server 140 via network 130 and interface 125. At server 140, attributes from the TEPC search query are applied to patent database 160 to generate a TEPC search result including, for each target entity, for each quarter within the period of interest, patent counts within each target classification and a total patent count. In this regard, a total patent count for a target entity is the sum of the patents on which one of the group of companies comprising the target entity is the listed assignee. A target patent count for a target entity is the sum of patents on which one of the group of companies comprising the target entity is the listed assignee and which is within the target classification. The TEPC search result is transmitted from server 140 to end-user station 110 via network 130 and interface 125 and the total patent counts and target patent counts for target entities are added to their associated entries in memory 122.

It will be appreciated that, at this point in the process, patent counts for the target entities during the period of interest, both for target classifications and overall, have been learned.

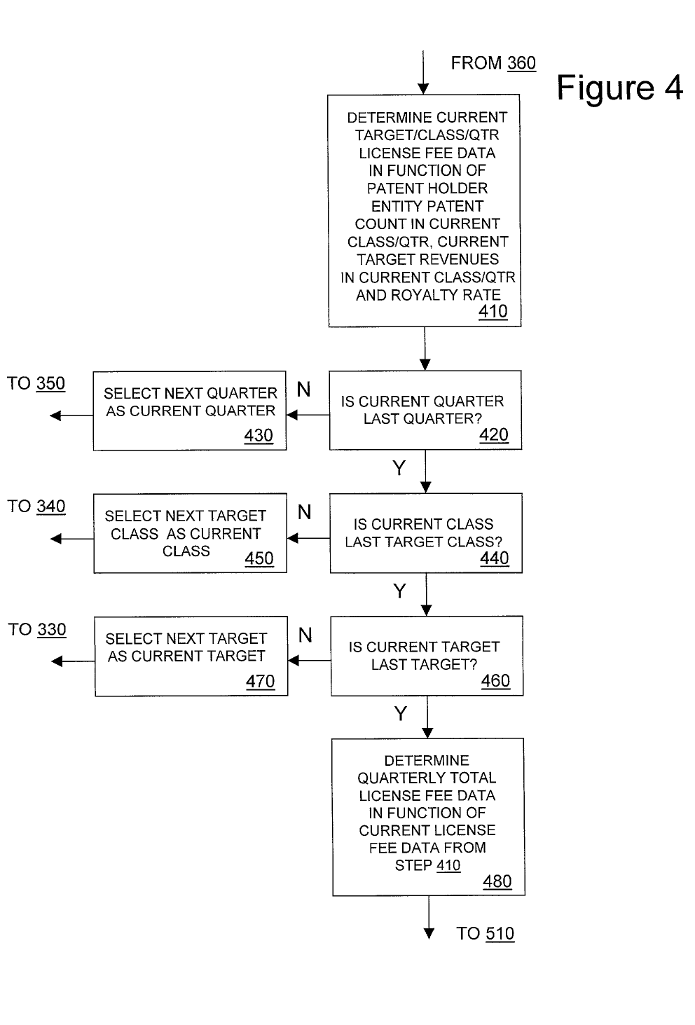

The data accumulated in memory 122 during the aforedescribed steps is therefore ripe for application on end-user station 110, more particularly through software program instructions implemented by processor 120, to determine a value for the patent holder's patent assets in accordance with the “cash out” licensing profits valuation methodology of the present invention. A first target entity (from among the target entities for which entries have been created in memory 122) is selected as the current target (320) and a first target class (from among the target classes stored in memory 122) is selected as the current class (330). The first quarter in the period of interest is selected as the current quarter (340). The patent count for the current target in the current class in the current quarter is divided by the total patent count for the current target in the current quarter to determine the fraction (percentage) of the current target's total patents in the current class in the current quarter (350). The fraction is multiplied by the current target's total revenue in the current quarter to estimate the current target's revenue attributable to the current class in the current quarter (360). Turning to FIG. 4! the estimated current target revenue attributable to the current class in the current quarter is multiplied by the patent holder's patent count in the current class in the current quarter and the royalty rate to determine license fee data for the current target in the current class in the current quarter (410). This value is the projected licensing revenue stream that could be realized by the patent holder from the current target in consideration of a license under the patent holder's patents in the current class in the current quarter. A check is made to determine if the current quarter is the last quarter (420). If the current quarter is not the last quarter, the next quarter is selected as the current quarter (430) and the flow returns to Step 350. If the current quarter is the last quarter, a check is made to determine if the current class is the last target class (440). If the current class is not the last target class, the next target class is selected as the current target class (450) and the flow returns to Step 340. If the current class is the last target class, a further check is made to determine if the current target is the last target (460). If the current target is not the last target, the next target is selected as the current target (470) and the flow returns to Step 330. If the current target is the last target, separately for each quarter within the period of interest, license fee data determined in Step 410 for all targets in all classes are summed to determine quarterly total license fee data (480). These values are the projected quarterly “cash out” licensing revenue streams that could be realized by the patent holder from all targets in consideration of licenses under the patent holder's patents in all classes

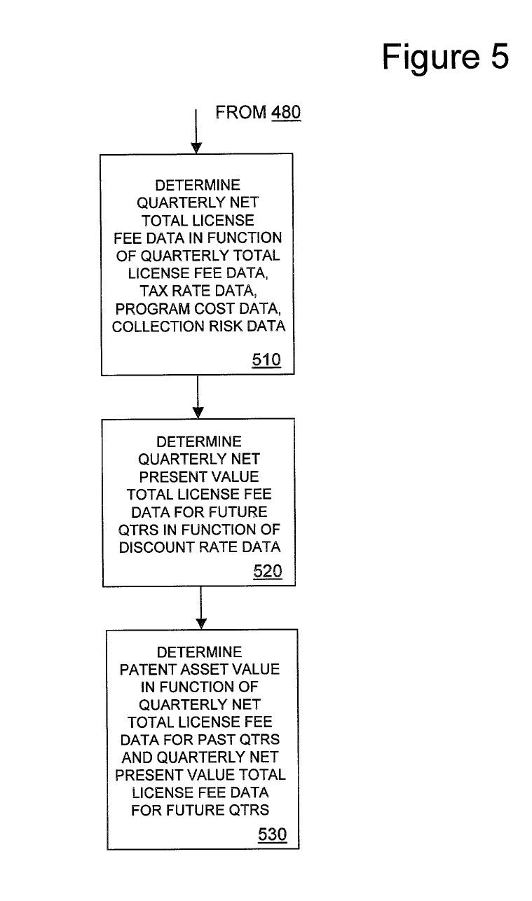

Turning lastly to FIG. 5, the projected quarterly “cash out” licensing revenue streams are converted to respective quarterly projected “cash out” licensing profits streams. Particularly, taxes as determined by tax rate data, program costs as determined by program cost data and collection risks as determined by collection risk data are subtracted from the quarterly total license fee data to produce quarterly net total license fee data (510). These values are the projected quarterly “cash out” licensing profits streams that could be realized by the patent holder from all targets in consideration of licenses under the patent holder's patents in all classes, before accounting for the time value of money. Finally, the quarterly net total license fee data for future quarters are discounted as determined by discount rate data to produce quarterly net present value total license fee data (520). Finally, quarterly net total license fee data for past quarters and quarterly net present value total license fee data for future quarters are summed to generate a patent asset value (530). The patent asset value is a measure of the projected “cash out” licensing profit that could be realized by the patent holder at the present time from all targets in consideration of licenses under the patent holder's patents in all classes during the period of interest.

It will be appreciated by those of ordinary skill in the art that the invention can be embodied in other specific forms without departing form the spirit or essential character hereof The present description is therefore considered in all respects illustrative and not restrictive. The scope of the invention is indicated by the appended claims, and all changes that come within the meaning and range of equivalents thereof are intended to be embraced therein.

I claim:

1. A method for valuing patent assets, comprising: identifying patent assets; identifying a plurality of licensing targets for the patent assets; determining a plurality of license fee data for the plurality of licensing targets, respectively; and determining a value of the patent assets in function of the plurality of license fee data.

2. The method of claim 1, wherein the method is performed in a networked computing environment.

3. The method of claim 1, wherein the plurality of licensing targets are identified, respectively, in function of technological overlap between the identified patent assets and patent assets of the plurality of licensing targets, respectively.

4. The method of claim 1, wherein the value of the patent assets is further determined in function of tax data.

5. The method of claim 1, wherein the value of the patent assets is further determined in function of license program cost data.

6. The method of claim 1, wherein the value of the patent assets is further determined in function of license fee collection risk data.

7. The method of claim 1, wherein the value of the patent assets is further determined in function of cash flow discounting data.

8. The method of claim 1, wherein the value is a net present value.

9. The method of claim 1, wherein the license fee data are determined in function of the patent assets, licensing target revenue data and a royalty rate.

10. A method for valuing patent assets, comprising: identifying a patent holder; identifying patent assets of the patent holder; identifying a plurality of licensing targets for the patent assets; determining a plurality of license fee data for the plurality of licensing targets , respectively; and determining a value of the patent assets in function of the plurality of license fee data.

11. The method of claim 10, wherein the method is performed in a networked computing environment.

12. The method of claim 10 , wherein the plurality of licensing targets are identified, respectively, in function of technological overlap between the identified patent assets and patent assets of the plurality of licensing targets, respectively.

13. The method of claim 10, wherein the value of the patent assets is further determined in function of tax data.

14. The method of claim 10, wherein the value of the patent assets is further determined in function of license program cost data.

15. The method of claim 10, wherein the value of the patent assets is further determined in function of license fee collection risk data.

16. The method of claim 10, wherein the value of the patent assets is further determined in function of cash flow discounting data.

17. The method of claim 10, wherein the value is a net present value.

18. The method of claim 10, wherein the license fee data are determined in function of the patent assets, licensing target revenue data and a royalty rate.

19. A networked computing system, comprising:
an end-user station having a user interface, for interacting with a user, and a network interface, for interacting with a network,
wherein the end-user station interacts with the network to determine a value of patent assets in response to identification of the patent assets in an interaction involving the user, and wherein the value of patent assets is determined in function of a plurality of projected license fee data for a respective plurality of projected licensing targets.

20. The system of claim 19, wherein the interaction with the network includes identifying the plurality of projected licensing targets.

21. The system of claim 19, wherein the value is a net present value.

22. The system of claim 19, wherein the interaction with the network includes search queries in one or more databases.

23. A software program having instructions for interacting with an end-user station, a user and a network to determine a value of patent assets in function of a plurality of projected license fee data for a respective plurality of projected licensing targets.

24. The software program of claim 23, wherein the value of the patent assets is further determined in function of tax data.

25. The software program of claim 23, wherein the value of the patent assets is further determined in function of license program cost data.

26. The software program of claim 23, wherein the value of the patent assets is further determined in function of license fee collection risk data.

27. The software program of claim 23, wherein the value of the patent assets is further determined in function of cash flow discounting data.

28. The software program of claim 23, wherein the value is a net present value.

29. The software program of claim 23, wherein the projected licensing targets are identified in function of technological overlap between the patent assets being valued and patent assets of the projected licensing targets.

30. A method for valuing patent assets, comprising: identifying a plurality of licensing targets in function of a projected interest in licensing the patent assets; determining a plurality of projected license fee data for the plurality of licensing targets, respectively; and determining a value of the patent assets in function of the plurality of projected license fee data.

31. The method of claim 30, wherein the method is performed in a networked computing environment.

32. The method of claim 30, wherein the projected interest is determined in function of technological overlap of the patent assets being valued with patent assets of the licensing targets.

33. The method of claim 30, wherein at least one of the plurality of licensing targets is a single unaffiliated company.

34. The method of claim 30, wherein at least one of the plurality of licensing targets is a group of affiliated companies.

35. The method of claim 30, wherein the projections are made over a period of interest.

36. The method of claim 35 , wherein the period of interest is determined in function of a statute of limitations for patent infringement.

37. The method of claim 35, wherein the period of interest is determined in function of a maximum patent term.
